(19) United States
(12) Patent Application Publication
(10) Pub. No.: US 2010/0052304 A1
(43) Pub. Date: Mar. 4, 2010

(54) FENDER WEAR PLATE GUARD

(75) Inventors: Mark S. Hann, Shorewood, IL (US); Kenneth J. Trevithick, Kingston, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/198,524

(22) Filed: Aug. 26, 2008

(51) Int. Cl. B62D 25/18

(52) U.S. Cl. 280/851

(57) ABSTRACT

A wear plate guard for installation on a downwardly facing fender assembly surface having a front leading edge and fender sidewalls is disclosed herein. The wear plate guard is an elongate member with a generally L-shaped configuration adapted to cover and protect the surface. The elongate member has a top surface and splashguard fin in perpendicular alignment with a hole formed therein and configured for attachment to one of the fender sidewalls. The assembly also includes at least one outer tab extending perpendicularly downward from an end of the wear plate guard top surface, having a hole located therein.

### TECHNICAL FIELD

The field of this innovation is wear plates generally, and more specifically metallic wear plate guards for fenders, the guard having splashguard properties.

### BACKGROUND

Large earth moving equipment, such as medium and large wheel loaders, are one type of machine that utilizes external coverings (e.g. fenders) over the traction devices or wheels. These external coverings typically include sidewalls or skirts that more or less cover the wheels in order to protect them, and may also streamline characteristics of the machine bodies. These coverings may be in the shape of an arc of a circle, curvilinear, or may involve straight lines and planes, but generally form a protective umbrella like covering over the wheels. These coverings are part of a group of components that may be manufactured as assemblies.

Because these machines often work in extremely hostile environments that may include mud, sand, dust, soil and a wide variety of other aggregate, there is often a risk of debris entering areas around the traction devices or wheels. Aggregate and small debris can be especially prevalent in the wheel well, and can get in tight surfaces, like the areas between the different components of the fender assembly. This may cause extreme wear and abrasion with the aggregate behaving like sandpaper. Environmental vibrations translated to the external cover or fender assembly by road noise only exasperates the situation.

Over the years, engineers have devised a long list of wear protective strategies intended to inhibit metal-to-metal contact. In fact, the use of wear plates dates far back, in conjunction with components on machines and vehicles. From those early dates forward, numerous manufacturers of metal devices for earth moving machines have included some guarding strategy to inhibit digestion of debris in and between critical metal contact points and provide strength of a potential area of structural weakness. These plates were typically flat straight pieces that varied widely in material properties but generally covered the area of concern in a localized or extended geometry to prevent wear. However, heretofore, none have addressed the simultaneous issues of wear, and the sandpaper type abrasion from aggregate lodged between tightly adjacent surfaces, plus the need for a strong device to provide splashguard blockage from excess dirt and debris which tends to soil the platform area, causing operator discomfort and non-ideal handling situations.

Further, many of these wear plates are particular to the specific machine geometry features that are not easily transferable to different designs. The wear plate protective strategy for one machine may be totally ineffective and inappropriate for a different machine design. With every new design, new wear plate and guarding strategies must be devised in order to specifically address the needs and geometry of each new design.

The present disclosure is directed to overcoming one or more of the problems set forth above.

### SUMMARY

The present disclosure, in one form, provides a wear plate guard for installation on a downwardly facing fender assembly surface having a front leading edge and fender sidewalls, the wear plate guard being an elongate member with a generally L-shaped configuration adapted to cover and protect the fender assembly surface. The elongate member has a top surface and splashguard fin portion in perpendicular alignment with a hole formed therein and configured for attachment to one of the fender sidewalls. The wear guard further includes at least one outer tab extending perpendicularly downward from an end of the wear plate guard top surface, having a hole located therein.

In another aspect, a method of inhibiting wear on a fender surface and debris entry into an area of surface-to-surface contact includes installing a fender wear plate guard having a generally L-shaped configuration onto a downwardly facing fender assembly surface having a front leading edge and fender sidewalls and aligning holes of the wear plate guard and fender side wall. Also, aligning holes of the fender assembly and the wear plate bracket, where the wear plate bracket is adjustable to aid in alignment, aligning the wear plate guard to the fender assembly front leading edge, exposing a small corner of the adhesive upper surface covering liner, confirming alignment and contact of vertical surfaces of the wear plate bracket and the fender sidewall, exposing the entire adhesive upper surface covering liner, pressing the wear plate guard onto the fender surface with sufficient force, and mechanically bolting both the wear plate guard to the fender sidewall and the wear plate guard to the wear plate bracket.

Other advantages and novel features of the present disclosure will become apparent from the following detailed description of the disclosure when considered in conjunction with the accompanying drawings.

### BRIEF DESCRIPTION OF THE DRAWINGS

FIG. 1 is a perspective view of a machine according to one aspect of the present disclosure;

FIG. 2 is a perspective view of an aspect of the present disclosure; and

FIG. 3 is a diagrammatic view of an embodiment of the present disclosure.

### DETAILED DESCRIPTION

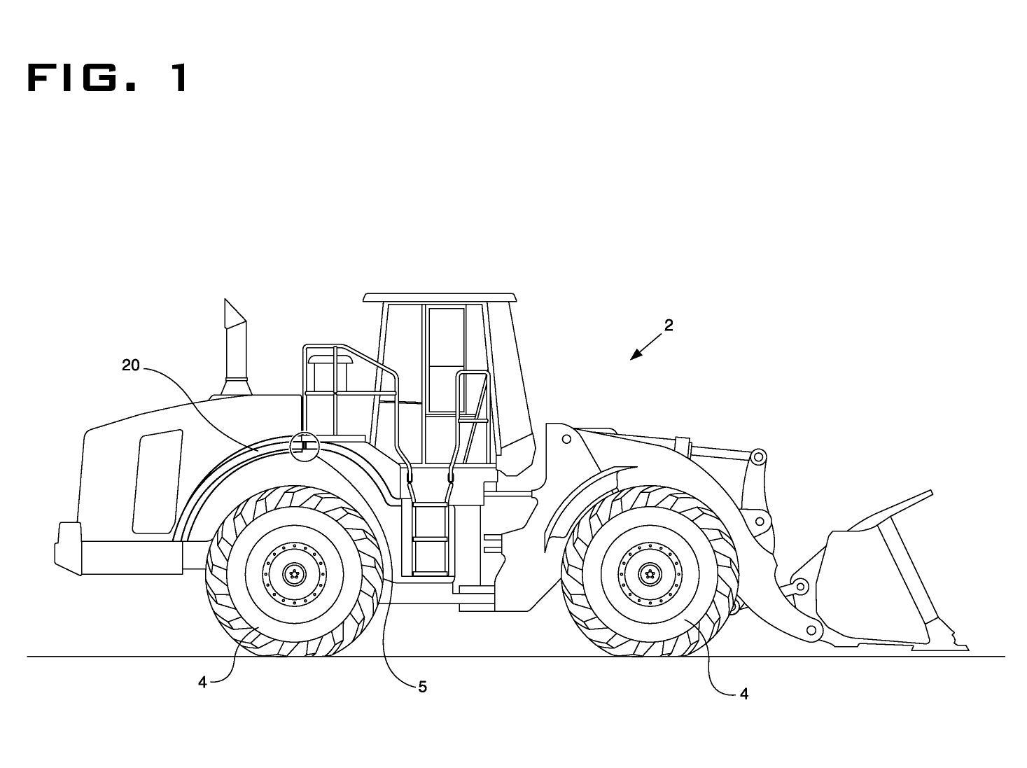

Referring now to the drawings wherein the showings are for the purpose of illustrating embodiments of the disclosure only, and not for the purpose of limiting the same, FIG. 1 illustrates the general location 5 of a wear plate guard 10 embodying the present disclosure in association with a machine 2. The machine 2 may have a pair of fender assemblies 20 located above the machine traction devices 4. While one wear plate guard 10 and fender assembly 20 are shown and discussed, it should be understood that each side would have similar wear plate guards 10 and assemblies 20. It is further contemplated that the machine may alternatively have two pairs of fender assemblies 20, each pair associated accordingly with the front set and rear set of machine traction devices 4, where applicable. The fender assemblies 20 may include but are not limited to metal or non-metallic fender members 22, support bumpers, deflectors, brackets, and various attachment means. By way of example, the assemblies have a front leading edge 23 which may align with and abut against an operator platform area 6.

The external coverings or fender members 22 found on large earth moving equipment and machines are sometimes made of non-metallic materials. This material, being of lighter weight and resiliency than traditional steel or other metal, may have support members attached thereto for alignment or centering, especially in areas where the fender member 22 lies adjacent to another structure on machine 2. The fender may be any shape, including arc shaped as shown. These non metallic fenders are often used to lighten the overall weight of the machines 2, and may also be used to avoid physical defects typically seen with metallic materials during manufacture, assembly, or repair, and fatigue life of the part.

In one embodiment the fender member 22 is comprised of ABS coextruded plastic or polycarbonate plastic. While the focus heretofore has been on a non-metallic fender, the fender may be made of any protective strength material known to one of skill in the art.

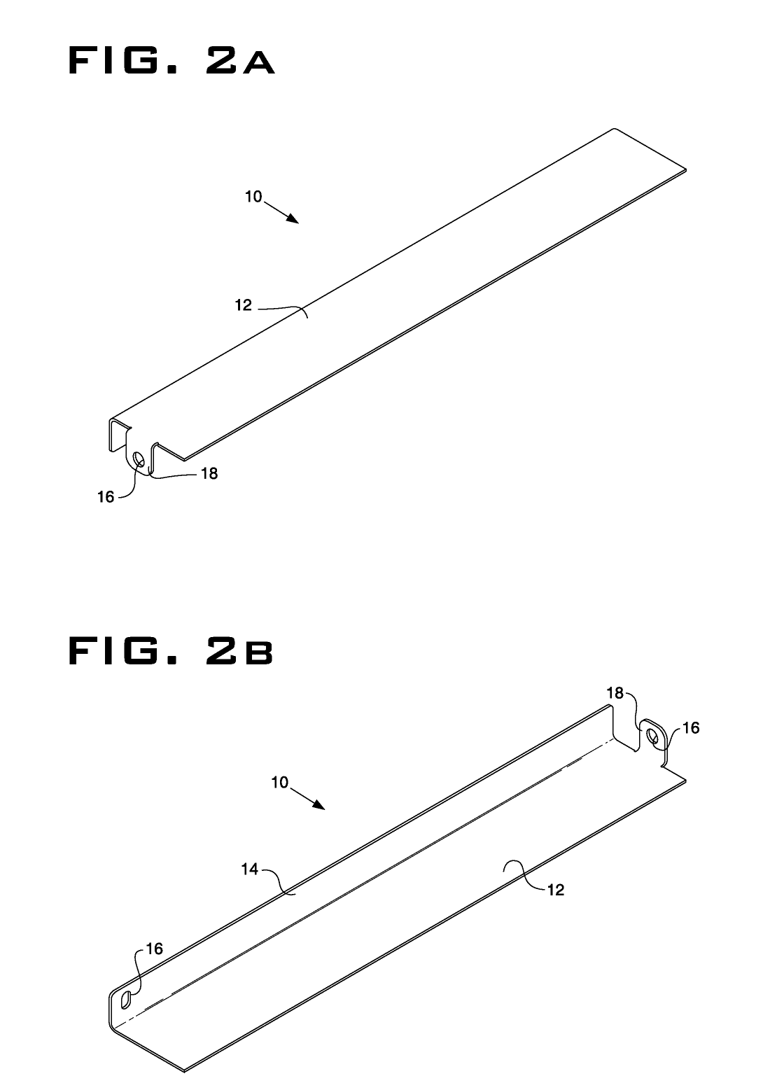

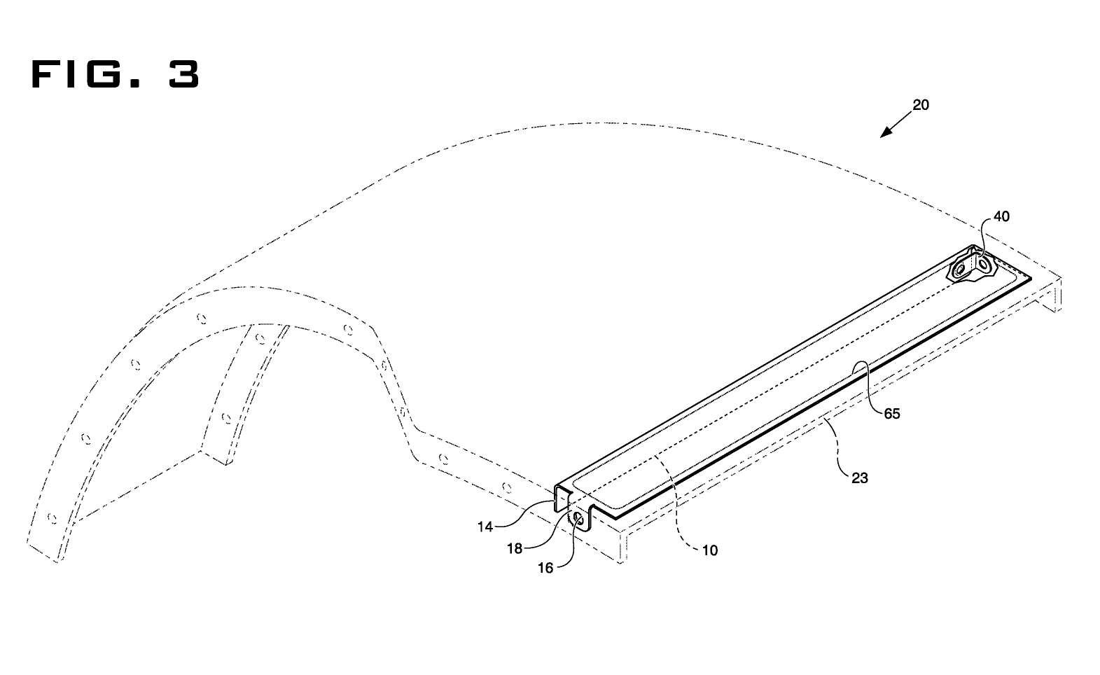

In accordance with one embodiment of the present disclosure, the wear plate guard 10 is shown in greater detail in FIG. 2, and comprises in general an L-shaped elongate member configuratively adapted to cover and protect the fender assembly surface. Specifically, the wear plate guard 10 consists of an essentially flat top portion 12 and perpendicularly extending splashguard fin portion 14. The splashguard fin portion 14 may have a hole 16 or other attachment means formed therein, and is configured for attachment to one of the fender sidewalls. The wear plate guard 10 further includes at least one outer tab 18 extending perpendicularly downward from an end of the wear plate guard top surface 12, having a hole 17 or slot located therein. The splashguard portion 14 may be aligned downwardly and rearward from the fender front leading edge 23. The tab 18 is dimensioned for alignment with exiting boltholes as shown in FIG. 3.

Preferably, the wear plate guard 10 is formed from a single piece of metal or other suitable material that is cut and bent into the configuration, as shown in FIG. 2. However, it should be appreciated that the wear plate guard 10 utilized in the present disclosure can be formed from any material that serves to protect the machine 2. Here, the wear plate guard 10 would optionally be made from steel.

The wear plate guard 10 may be mechanically secured as by bolt or the like, to its associated fender member 22 on downwardly facing surfaces. As typical of other various means that may be used to secure a wear plate guard 10 to a fender, there is illustrated in FIG. 3 fastening means comprising nut and bolt assembly 70 passing through the at least one tab 18, and fender member 22. It is, of course, within the scope of this disclosure and it will be understood that other equivalent means may be employed instead.

The fender may be attached to a bumper bracket 40 having a series of bumpers 50 for support and alignment of the fender assembly 20 to the machine 2.

The wear plate guard 10 is shown within a fender assembly, generally at FIG. 3. Therein, a bumper bracket 40 may be disposed between the fender member 22 and the wear plate guard 10, optionally having an L-shaped configuration, and may house a plurality of support bumpers 50 for alignment of the fender to a platform area 6 or other structure of the machine 2. The bumper bracket cooperates therewith to provide stability and orientation for the plurality of bumpers 50. The bumpers 50 may be formed from plastic, metal, or any other suitable material. As shown, installed, the bumpers 50 may abut the fender assembly downwardly facing surface at the second edge and subsequently below and forward of the wear plate guard 10.

The adhesive 65 has an upper and lower surface, the lower surface of the adhesive 65 being adhered to said wear plate guard top surface 12, and the upper surface of the adhesive 65 being adhered to the downwardly facing fender assembly surface 20.

Vibrational damping materials have been used to reduce the effects, e.g., disruption and/or damage, caused by vibrations for many years in applications where vibrational energy, e.g., transmitted by the operation of machines or equipment, is encountered.

An example of commercially successful damping materials include tapes made with copolymers of isooctyl acrylate and acrylamide which can function both as bonding adhesives and as vibrational insulators of two joined surfaces or members. The acrylic copolymer foam provides a high bonding force between polyolefin or metal surfaces, or both, while insulating the two surfaces from direct contact with each other thereby reducing the potential for wear damages due to rubbing or repeated direct impact if subjected to vibration or resonance phenomenon, or other prohibative forces. One illustrative example of this kind of product is 3M™ VHB™ Acrylic Foam Bonding Tape, e.g., Tape No. 4936, among others.

These tapes are known for applications such as the assembly of plastic or metal structures with close proximity and other reduced spaces. Here, the securement means includes a non-hardening, two-sided acrylic foam bonding adhesive material that may be die-cut in a variety of pad sizes for a predetermined holding strenth for the particular object being secured.

As a result, the pressure sensitive adhesive 65 provides mechanical attachment properties but more significantly, adds shock absorptive protection to reduce road noise and vibration. Additionally, the adhesive 65 also preferably covers the base portion and can take up excess clearance between the two surfaces to prevent aggregate from becoming lodged between the downwardly facing fender surface and the support bumpers 50, creating abrasive industrial sandpaper wear effects.

Installation and alignment of the wear plate guard 10 is as follows and is given in reference to the placement of the support bumpers 50 within the fender assembly 20. By way of example, when the wear plate guard 10 is installed in the fender assembly 20, the top portion 12 contacts the fender member 22 via the adhesive (not shown), and the outboard tab 18 abuts the fender sidewall 24. One of skill in the art, however, will readily recognize that the guard 10 may be placed in any alignment that shields the surface-to-surface contact of the bumpers 50 to the fender member 22.

Turning again to the illustrated fender assembly 20 in FIG. 2, the wear plate guard 10 is shown assembled with the bumper bracket 40 in place, creating the previous contact surface of the bumpers 50 to the fender assembly downward facing surface. The bumper bracket 40 is fixedly attached to the rear edge of the platform surface area 6 and may extend horizontally across the fender assembly downwardly facing surface, between the fender assembly sidewalls. A cross-sectional cut through the fender assembly 20 reveals that the bumper bracket 40 is aligned beneath the wear plate guard bottom surface so that the bumpers 50 and the fender downwardly facing surface are no longer in direct contact.

During installation, an adhesive surface (not shown) is exposed by peeling the adhesive backing from the adhesive 65. In one embodiment, adhesive 65 is added to the wear plate guard 10 before the wear plate guard 10 is placed within the fender assembly 20. Alternatively, the adhesive 65 may be added to the guard 10 prior to mounting the wear plate guard 10 to the fender assembly 20.

The wear plate guard 10 of this disclosure may be placed in existing fenders of conventional design, thus enabling the economical adaptation of existing fenders. In addition, if desired, the wear plates may be attached in any suitable configuration, to accommodate existing fastening mechanisms or fender geometry.

It will be appreciated by those skilled in the art that the overall dimensions of the wear plate guard 10, and the thickness of the adhesive 65 and the guard 10 itself, are a function of the size, shape and length of the fender assembly 20.

### INDUSTRIAL APPLICABILITY

The industrial applicability of a wear plate guard 10 for a surface described herein will be readily appreciated from the foregoing discussion. The present disclosure finds potential application to any earth-moving machine in which the desire is to inhibit aggregate from entering an area of tight fit between two surfaces, while preventing wear. This strategy allows the wear plate guard 10 guard of the present disclosure to interact with the fender assembly 20 to prevent support bumpers from being in direct contact with the fender and includes at least one full strip of pressure sensitive foam bonding adhesive 65 and a downwardly sweeping guard surface to present a combined layered line of defense against entry of undesirable aggregate into the area between the assembly. The adhesive simultaneously provides vibration absorbing properties, as well as a further shield from road dust and dirt. The present disclosure finds specific applicability to wheel loader and like machines that operate in hostile environments, including but not limited to mud, sand, dust and a variety of other debris that could potentially undermine the integrity of the non-metallic or metallic surface area of a external covering of the machine.

Examples of the present disclosure are applicable to any fender or quarter panel assembly system, especially one employing a non-metallic piece in direct contact with a support surface or device, further where the assembly or machine is operated in a harsh environmental terrain. The wear plate guard 10 of the present disclosure is advantageous where it is desired that the wear surfaces are protected and covered, and better shielded from aggregate. For example, many machines, such as wheel loaders, have a plurality of fender assemblies that are manufactured from plastic or other non-metallic materials and which are in direct contact with support bumpers and the like, may benefit from application of the teachings herein. In such assemblies, application of the foregoing device may provide longer wearing non-metallic pieces, and better quality machine parts, free from abrasive wear and cracks, etc.

It will be appreciated that the foregoing description provides examples of the disclosed device. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely, unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A wear plate guard for installation on a downwardly facing fender assembly surface having a front leading edge and fender sidewalls, comprising:
an elongate member having a generally L-shaped configuration adapted to cover and protect said surface;
said elongate member having a top surface and a splashguard fin portion in perpendicular alignment, said splashguard fin portion having a hole formed therein and configured for attachment to one of said fender sidewalls; and
at least one outer tab extending perpendicularly downward from an end of said top surface, having a hole located therein.

2. The wear plate guard, as set forth in claim 1, wherein each end is mechanically attached to the fender assembly.

3. The wear plate guard, as set forth in claim 1, wherein the top surface is adhesively connected to the fender assembly.

4. The wear plate guard, as set forth in claim 3, wherein said adhesive is an acrylic foam bonding material.

5. The wear plate guard as set forth in claim 3, wherein said adhesive has an upper and lower surface, the lower surface of said adhesive being adhered to said wear plate guard top surface, and the upper surface of said adhesive being adhered to said downwardly facing fender assembly surface.

6. The wear plate guard, as set forth in claim 1, wherein each end is mechanically attached to the fender assembly.

7. The wear plate guard, as set forth in claim 1, wherein said splashguard fin portion is in attachment communication with a wear plate guard bracket attached to said fender sidewall.

8. The wear plate guard, as set forth in claim 7, wherein said wear plate guard bracket is essentially L-shaped.

9. The wear plate guard, as set forth in claim 1, wherein said wear plate guard has essentially the same length as the distance between said fender assembly sidewalls.

10. The wear plate guard, as set forth in claim 1, wherein the underside of said top surface of said wear plate guard is in surface-to-surface communication with a plurality of fender alignment support bumpers.

11. The wear plate guard, as set forth in claim 10, wherein said fender alignment support bumpers are attached to a bumper bracket.

12. A method of inhibiting wear on a fender surface and debris entry into an area of surface-to-surface contact, comprising the steps of:
installing a fender wear plate guard on a downwardly facing fender assembly surface having a front leading edge and fender sidewalls, said wear plate guard having a generally L-shaped configuration adapted to cover and protect said surface;
said elongate member having a top surface and a splashguard fin in perpendicular alignment, said splashguard fin having a hole formed therein and configured for attachment to one of said fender sidewalls; and at least one outer tab extending perpendicularly downward from an end of said top surface, having a hole located therein; further comprising the steps of:
aligning holes of the wear plate guard and fender side wall;
aligning holes of the fender assembly and the wear plate bracket, wherein said wear plate bracket is adjustable to aid in alignment;
aligning the wear plate guard to the fender assembly front leading edge;
exposing a small corner of the adhesive upper surface covering liner;
confirming alignment and contact of vertical surfaces of the wear plate bracket and the fender sidewall;
exposing the entire adhesive upper surface covering liner;
pressing the wear plate guard onto the fender surface with sufficient force; and,
mechanically bolting both the wear plate guard to the fender sidewall and the wear plate guard to the wear plate bracket.

13. The method, as set forth in claim 12, wherein the underside of said top surface of said wear plate guard is in surface-to-surface communication with a plurality of fender alignment support bumpers.
